(19) United States
(12) Patent Application Publication
(10) Pub. No.: US 2019/0065707 A1
(43) Pub. Date: Feb. 28, 2019

(54) MANAGEMENT APPARATUS, CONTROL METHOD, AND STORAGE MEDIUM

(71) Applicant: CANON KABUSHIKI KAISHA, Tokyo (JP)

(72) Inventor: Satoshi Nishikawa, Yokohama-shi (JP)

(21) Appl. No.: 16/107,156

(22) Filed: Aug. 21, 2018

(30) Foreign Application Priority Data
Aug. 29, 2017 (JP) 2017-164715

(51) Int. Cl. G06F 21/10; G06F 3/12

(52) U.S. Cl. CPC G06F 21/105; G06F 2221/0773; G06F 3/123

(57) ABSTRACT

A management apparatus displays a warning indicating that an installation license will not be updated in an image forming apparatus when the installation task of a second application in the image forming apparatus is prepared, usage information of the image forming apparatus has not been registered in a license management system, or the image forming apparatus has failed to communicate with the license management system in accordance with the instruction, and prepares an installation task for delivering the second application and the installation license or the installation license when the usage information of the image forming apparatus has been registered in the license management system and the image forming apparatus has succeeded in communicating with the license management system in accordance with the instruction.

### BACKGROUND OF THE INVENTION

### Field of the Invention

The present invention relates to a management apparatus, a control method, and a storage medium.

### Description of the Related Art

In the related art, a device management system and a management apparatus that acquire and manage data such as operation information of image forming apparatuses such as printers or multifunction machines are known. In view of an increase in the number of image forming apparatuses to be managed and decrease in cost and amount of maintenance of a management server, there is demand for an increase in the number of image forming apparatuses that can be managed by one management apparatus. In such a device management system, the management apparatus transmits an application and a license required for use of the application or only the license to an image forming apparatus and the image forming apparatus performs an installation process.

Japanese Patent Laid-Open No. 2009-163480 discloses that it is determined whether there is a license of which a term of validity is less than a predetermined period in an environment in which the number of apparatuses using each license is correlated with the number of valid licenses. Japanese Patent Laid-Open No. 2009-163480 also discloses that when some licenses become unavailable, validity of a license is maintained for an apparatus which is set as a candidate in which the license is enabled in advance by a user.

However, in Japanese Patent Laid-Open No. 2009-163480, only licenses in which a fixed term of validity is set are considered for a type of licenses to be delivered. When a type of a license to be delivered or the like is not taken into account for delivery of a license or a license and an application, the management apparatus side may not be able to appropriately perform setting or control of delivery and a delivery operation assumed by a manager may not be realized.

### SUMMARY OF THE INVENTION

The invention provides a management apparatus that can appropriately control management and delivery of an application and a license for the application.

A management apparatus according to an embodiment of the invention includes: a transmission unit that transmits an instruction causing an image forming apparatus to communicate with a license management system to the image forming apparatus when setting of delivery of an application and an installation license for the application or the installation license to the image forming apparatus is performed; a display unit that displays a warning indicating that a license to be delivered to the image forming apparatus will not be updated when the license management system does not manage registration information of the image forming apparatus or the image forming apparatus has failed to communicate with the license management system in accordance with the instruction; and a delivery unit that delivers the application and the installation license or the installation license on the basis of the setting of delivery when the license management system manages the registration information of the image forming apparatus and the image forming apparatus has succeeded in communicating with the license management system in accordance with the instruction.

Further features of the present invention will become apparent from the following description of exemplary embodiments (with reference to the attached drawings).

### BRIEF DESCRIPTION OF THE DRAWINGS

FIG. 1 is a diagram illustrating a system configuration of a device management system;

FIG. 2 is a diagram illustrating an example of a hardware configuration of a management server;

FIG. 3 is a diagram illustrating a software configuration of the management server;

FIG. 4 is a diagram illustrating a software configuration of an image forming apparatus;

FIG. 5 is a configuration illustrating an example of a configuration of an application file;

FIGS. 6A to 6C are diagrams illustrating an example of a configuration of a license file and features of various licenses;

FIG. 7 is a diagram illustrating an example of an operating sequence of a second application;

FIG. 8 is a diagram illustrating a process routine of preparing an installation task of a second application;

FIG. 9 is a diagram illustrating a process routine of preparing an installation task of a second application;

FIG. 10 is a diagram illustrating a process routine of preparing an installation task of a second application;

FIG. 11 is a diagram illustrating an operating sequence before an installation task is prepared;

FIG. 12 is a diagram illustrating an operating sequence before an installation task is prepared;

FIG. 13 is a diagram illustrating an example of details of an installation license;

FIGS. 14A and 14B are diagrams illustrating display of a warning;

FIG. 15 is a diagram illustrating a process routine of preparing an installation task of a second application;

FIG. 16 is a diagram illustrating a process routine of preparing an installation task of a second application;

FIG. 17 is a diagram illustrating a process routine of preparing an installation task of a second application;

FIG. 18 is a diagram illustrating an operating sequence before an installation task is prepared;

FIG. 19 is a diagram illustrating an operating sequence before an installation task is prepared; and

FIGS. 20A and 20B are diagrams illustrating display of a warning and display associated with stopping of preparation of a task.

### DESCRIPTION OF THE EMBODIMENTS

Hereinafter, embodiments of the present invention will be described with reference to the accompanying drawings or the like.

### First Embodiment

<Description of System Configuration>

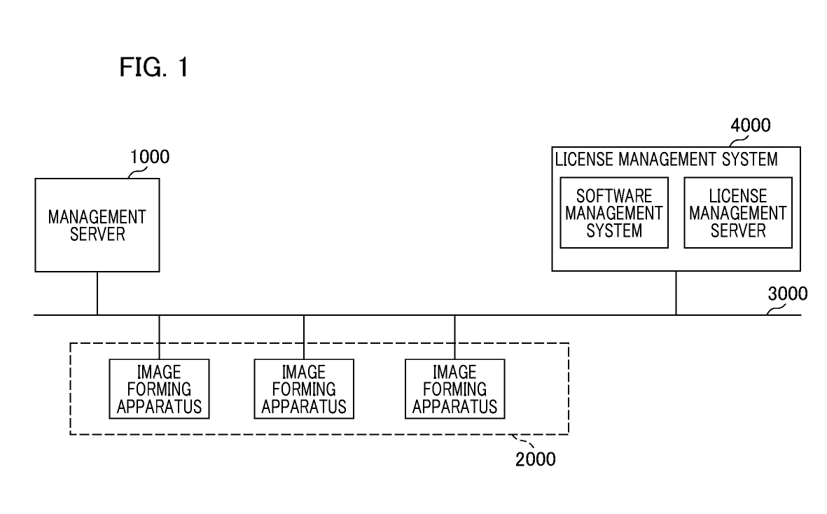

FIG. 1 is a diagram illustrating an example of a system configuration of a device management system according to an embodiment of the invention.

In FIG. 1, a device management system includes a management server 1000, one or more image forming apparatuses 2000, and a license management system 4000. The management server 1000, the image forming apparatuses 2000, and the license management system 4000 are communicatively connected to each other via a network 3000 based on Ethernet (registered trademark) or the like.

Each image forming apparatus 2000 receives print data from a client computer (not illustrated) via the network 3000 and performs printing on an actual sheet of paper using printing technology such as electrophotography technology or ink jet technology. The image forming apparatus 2000 has a function of reading a paper original via a scanner and copying the read paper original or converting the read paper original into image data and transmitting the image data by e-mail or the like. An image forming apparatus 2000 not having a copying function or an image forming apparatus 2000 not having a scanner function can be used. The image forming apparatus 2000 can have a function added thereto by installing an application. Examples of the image forming apparatus include a printer and a multifunction machine.

The management server 1000 collects and manages a variety of data from the image forming apparatuses 2000 or controls management and delivery of an application for the image forming apparatuses 2000 and a license of the application. The license management system 4000 is a system that manages various licenses required for installing an application in the image forming apparatuses 2000 and enabling the application. The license management system 4000 includes a license management server and a software management system.

It is assumed that each image forming apparatus 2000 communicates with the software management system of the license management system 4000 via a LAN, the Internet, and the like. Communication between the image forming apparatus 2000 and the license management system 4000 may be performed without passing through the software management system, that is, the image forming apparatus 2000 may directly communicate with the license management server. In this case, the license management system 4000 may include only the license management server.

<Hardware Configuration of Management Server>

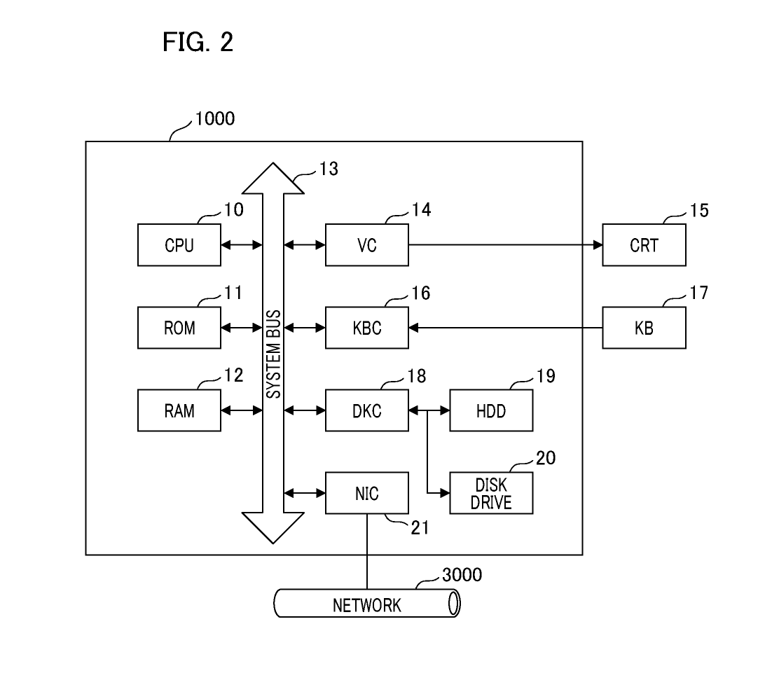

FIG. 2 is a diagram illustrating an example of a hardware configuration of the management server 1000.

The management server 1000 includes a CPU 10 that executes various programs such as an OS, firmware, an application program, and device management software which will be described later and which are stored in a ROM 11 or a HDD 19. The CPU 10 collectively controls hardware connected to a system bus 13.

More specifically, the CPU 10 realizes functions of a device managing unit 30 of the management server 1000 by executing programs stored in the ROM 11 and the HDD 19. Functions (a software configuration) of the management server 1000 and processes of flowcharts which will be described later are realized by the device managing unit 30.

The programs causing the CPU 10 to realize the device managing unit 30 are supplied, for example, by a storage medium such as a flexible disk (FD), a CD-ROM, a DVD, a magnetic tape, or an IC memory card which can be mounted on a disk drive 20. Here, the disk drive 20 and the HDD 19 are connected to the system bus 13 via a disk controller (DKC) 18. A RAM 12 serves as a main memory and a work area of the CPU 10.

The CPU 10 displays a user interface on a display device (CRT) 15 via a video card (VC) 14. The CPU 10 performs control based on an input instruction to the user interface which is received from a keyboard (KB) 17 via a keyboard controller (KBC) 16 or a pointing device such as a mouse. The CPU 10 performs data communication with the image forming apparatuses 2000 and the license management system 4000 in the network 3000 via a network interface board (NIC) 21.

<Software Configuration of Management Server>

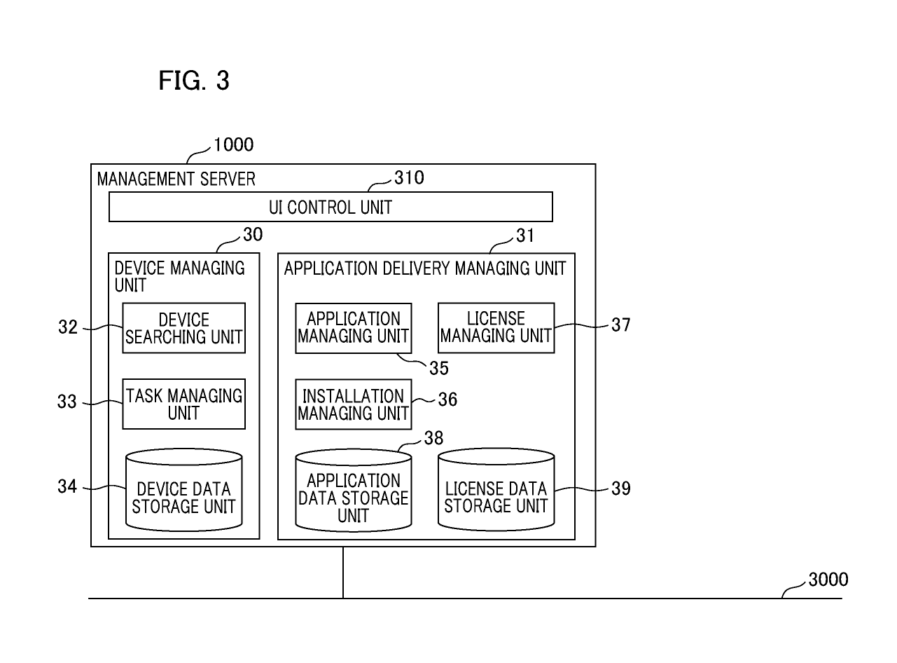

FIG. 3 is a diagram illustrating a configuration of device management software that operates in the management server 1000.

In FIG. 3, the management server 1000 includes a device managing unit 30, an application delivery managing unit 31, and a UI control unit 310.

Various software modules illustrated in FIG. 3 serve as entities for processing of device management software which will be described later. The UI control unit 310 provides a graphical user interface for allowing a manager of an image forming apparatus 2000 to operate the software. The graphical user interface is configured to be displayed on a display device 15 of the management server 1000. Alternatively, the graphical user interface may be configured as a web application which can be used via a web browser by another client PC using Hyper Text Transfer Protocol (HTTP).

The device managing unit 30 includes a device searching unit 32, a task managing unit 33, and a device data storage unit 34. The device searching unit 32 prepares a task for detecting the image forming apparatuses 2000 connected to the network 3000 and stores the task in the device data storage unit 34. The device searching unit 32 controls execution of the prepared task. The device searching unit 32 searches the image forming apparatuses 2000 connected to the network 3000 using techniques such as SNMP, IP broadcast, or SLP/Multicast.

The device searching unit 32 searches the image forming apparatuses 2000 at an arbitrary time. In this embodiment, the device searching unit 32 acquires device information such as device names, product names, and IP addresses as a result of device searching and stores the device information in the device data storage unit 34. The device searching unit 32 has a function of acquiring/changing a variety of information of the image forming apparatuses 2000 using techniques such as management information base (MIB) via the network 3000.

The task managing unit 33 has a function of executing the task which is prepared by the device searching unit 32 or an installation managing unit 36 and stored in the device data storage unit 34. A function of causing the management server 1000 to execute the task and execution conditions such as execution times (a schedule) are set in the task. The task managing unit 33 instructs the device searching unit 32 having stored the task or the installation managing unit 36 to execute the task in accordance with the schedule set in the task.

The device data storage unit 34 is a data storage medium such as a database that operates in the HDD 19 and stores table data such as a device list. Information of devices which are managed by the management server 1000 is stored in the device list. Information of devices is information such as serial numbers of devices, devices names, address information (IP addresses), and a firmware version of devices, and installation places.

The application delivery managing unit 31 includes an application managing unit 35, an installation managing unit 36, a license managing unit 37, an application data storage unit 38, and a license data storage unit 39. The application managing unit 35 manages information of an application file which will be described later. An application file is configured as one file into which a plurality of files are compressed such as a CAB file, a JAR (Java (registered trademark) ARchive) file, or a ZIP file.

The application managing unit 35 receives an application file from the UI control unit 310, decompresses the application file, and then extracts a manifest file therefrom. Then, the application managing unit 35 construes the manifest file and extracts application attachment information such as an application name, an application ID, and a version. Thereafter, the application managing unit 35 stores the application attachment information along with the application file in the application data storage unit 38.

The installation managing unit 36 receives an installation instruction from the UI control unit 310, connects to an image forming apparatus 2000, and prepares (registers) a task for requesting the image forming apparatus 2000 to install an application. The license managing unit 37 manages information on a license registered via the UI control unit 310. The license managing unit 37 extracts information such as an application ID or a serial number of the image forming apparatus as an installation destination from the registered license and stores the information along with the license in the license data storage unit 39.

<Software Configuration of Image Forming Apparatus>

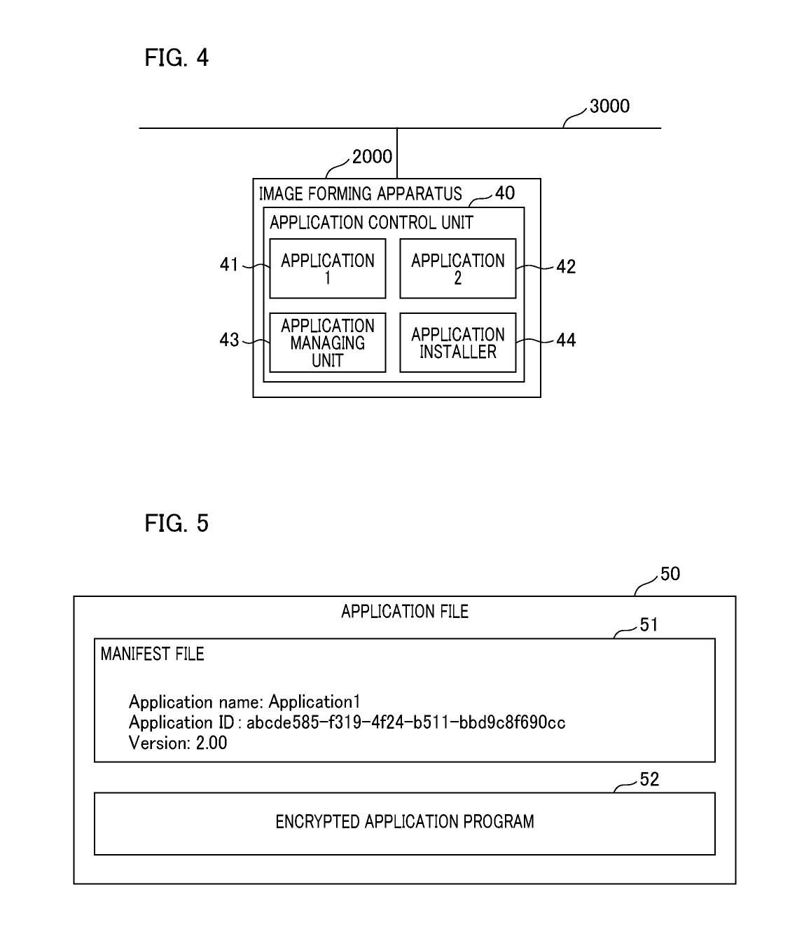

FIG. 4 is a diagram illustrating a software configuration of an application control unit 40 that operates in an image forming apparatus 2000.

The application control unit 40 performs control such as start/stop/installation/update/uninstallation of an application that operates in the image forming apparatus 2000. The application control unit 40 includes an application managing unit 43 and an application installer 44. The application managing unit 43 is a software module that manages a plurality of application groups that can be dynamically installed.

Applications 41 and 42 are application programs (hereinafter referred to as applications) that operate under the control of the application managing unit 43 and realize various functions of the image forming apparatus 2000. The applications 41 and 42 provide a user with various functions in cooperation with the image forming apparatus 2000. That is, the application managing unit 43 causes applications for providing various services of the image forming apparatus 2000 to operate.

Applications include applications of which a license required for enabling the corresponding applications is managed and applications of which a license is not managed or not required. The applications of which a license is managed are classified into two types depending on the type of the license. One is an application which is enabled by a license with a fixed term of validity and which is referred to as a first application. An application of which a license has an indefinite term of validity is included in the first application.

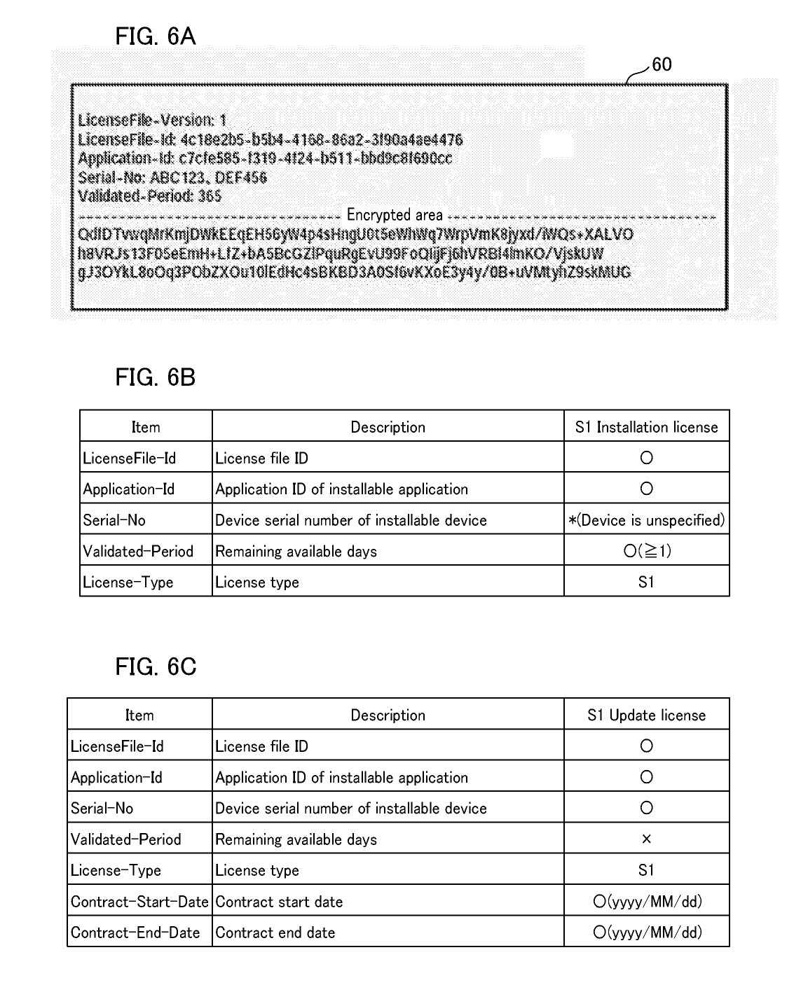

The other is an application which is continuously enabled by a license of which the term of validity is updated by communicating with an external system, for example, the license management system 4000 in this embodiment and which is referred to as a second application. The licenses that enable the second applications include an installation license and an update license. These will be described in detail with reference to FIGS. 6A to 6C. In the external system, image forming apparatuses serving as an installation destination of the second application, various applications, and licenses for the various applications are managed.

Examples of the applications 41 and 42 include an application for processing and compressing an image, an application for performing department management such as printing restriction, and a plug-in module that is installed as a part of an application. Examples of the applications 41 and 42 include an application for remotely managing an image forming apparatus 2000 and an application for controlling a unit such as a finisher of an image forming apparatus 2000 such that bookbinding is performed.

Examples of the applications 41 and 42 include an application for converting and analyzing specific document data. Examples of the applications 41 and 42 include a document preparing program such as so-called word processor software, a schedule managing program, a spreadsheet program, and a database managing program. Examples of the applications 41 and 42 include a server program for realizing a printing service via the Internet.

The application installer 44 installs an application in an image forming apparatus 2000, and the application managing unit 43 adds the applications 41 and 42 to management objects in response to installation of the application. The application installer 44 deletes an application from the image forming apparatus 2000, and the application managing unit 43 excludes the applications 41 and 42 from the management objects in response to deletion of the application.

<Configuration of Application File>

FIG. 5 is a diagram illustrating an example of a configuration of an application file that is delivered from the management server 1000.

An application file is a file including a file of an application program (which may be compressed) and a meta data file thereof.

In FIG. 5, an application file 50 is configured as one file into which a plurality of files are compressed such as a CAB file, a JAR (Java (registered trademark) ARchive) file, or a ZIP file. The application file 50 includes a manifest file 51 and an application program 52.

Application attachment information such as an application name, an application ID for uniquely identifying the application, and a version is described in the manifest file 51. The application program 52 in the application file 50 is encrypted to prevent falsification of the program by a third party or the like. The application file 50 is distributed to users via a storage medium such as a CD or media such as the Internet.

<Configuration of License File>

FIG. 6A is a diagram illustrating an example of a configuration of a license file that is delivered from the management server 1000.

An application ID (Application-Id) of the application that is enabled by the corresponding license is described in the license file 60. The application ID is an identifier for uniquely identifying the application.

Information such as a serial number (Serial-No) of the image forming apparatus 2000 in which installation of the application is permitted and a term of validity (Validated-Period) is described in the license file 60. In the license file 60, information such as a license key is encrypted and stored in the license file in order to prevent falsification of the license file by a third party.

For example, a user of a first application sends a serial number of the image forming apparatus 2000 in which the application is used and a license certificate number (ID) included in a package of application to a license issuer. The license issuer prepares a license file 60 from the serial number and the license certificate number (ID) and distributes the license file to the application user via a storage medium such as a CD or a medium such as the Internet.

FIGS. 6B and 6C are diagrams illustrating features of the license for the second application.

The license for the second application includes an installation license and an update license. The installation license is a license for installing the second application which is used at the time of installation. FIG. 6B illustrates features of the installation license.

A device (an image forming apparatus in this embodiment) which is an object of the installation license is unspecified. That is, a specific device is not described using Serial-No in the license file. A remaining term of validity is set to be fixed as a period (a term of validity) in which the second application is enabled by the installation license.

For example, the number of remaining available days may be set as Validated-Period in the license file. Even when the term of validity has expired, the second application can be installed. However, even when the application is installed using the license of which the term of validity has expired, the application is not enabled and thus usage thereof cannot be started.

The update license is periodically acquired from an external system by a device in which the second application has been installed. By allowing the device to enable (start usage) the second application using the update license, the device can continue to use the second application. FIG. 6C illustrates features of the update license.

A device which is an object of the update license is set to be fixed. For example, a specific device is described as Serial-No in the license file. A start time and an end time of an enabled period are set to be fixed as a period (a term of validity) in which the second application is enabled by the update license.

For example, in the license file, a contract start date of the second application is described as Contract-Start-Date and a contract end date of the second application is described as Contract-End-Date. In a device which is an object of an update license, the update license may also be used to install the second application.

<Operating Sequence of Second Application>

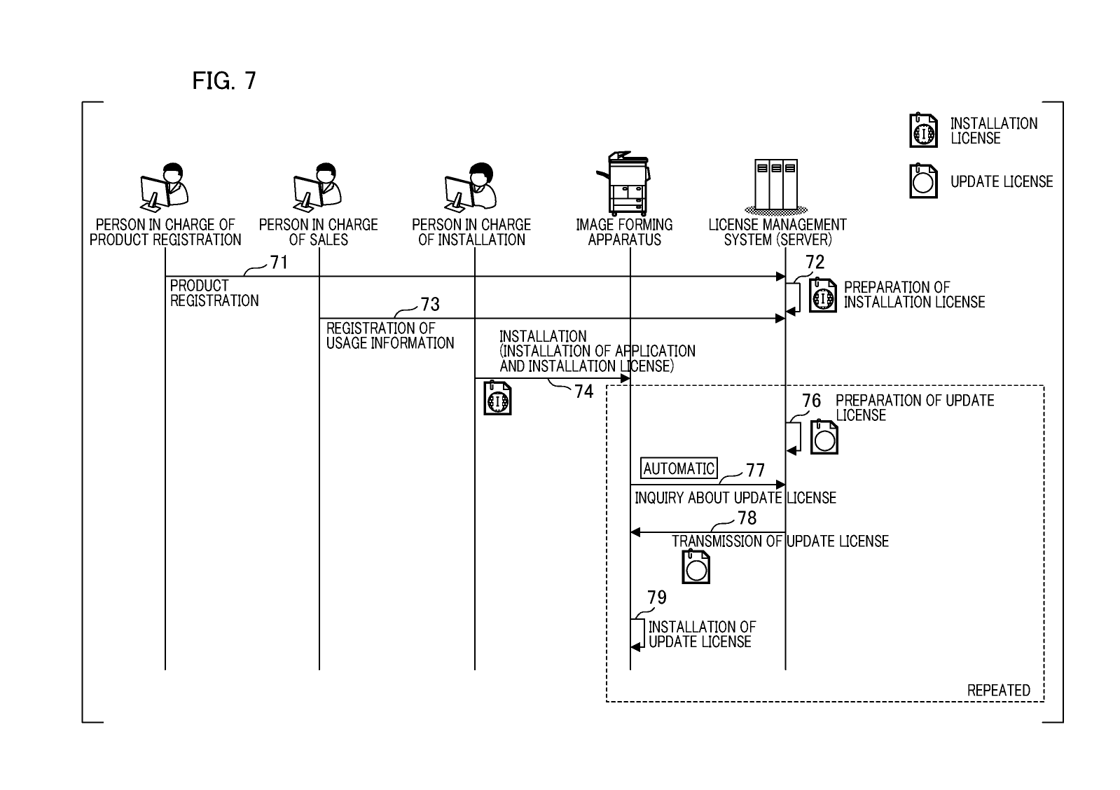

FIG. 7 is a diagram illustrating an example of an operating sequence of a second application.

First, a person in charge of product registration performs product registration (71) of a second application to be sold in the license management server of the license management system 4000. At this time, the second application as a product type and a term of validity after being installed are set. When the product registration (71) of the second application is received, the license management server performs preparation (issuance) (72) and registration (73) of an installation license for the application.

A person in charge of sales performs registration (73) of usage information in the license management server. The usage information includes information such as a serial number of an image forming apparatus which utilizes the second application and a term of validity of the second application. An update license is issued by performing registration of usage information, and the image forming apparatus can continuously use the second application by acquiring the update license.

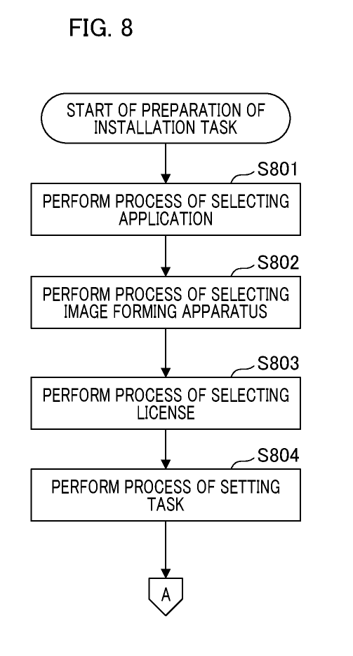

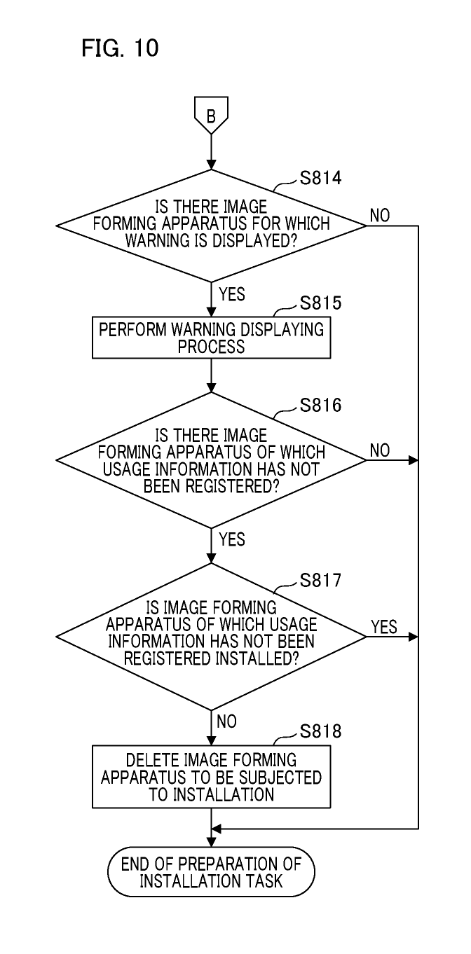

A person in charge of installation performs installation work (74) on the image forming apparatus using the second application and the installation license. Specifically, the second application is installed along with the installation license. As will be described later, the person in charge of installation can install an application in the image forming apparatus even when installation work (74) is not directly performed on the image forming apparatus by preparing (registering) an installation task in the management server 1000. Details of the preparation of an installation task will be described later with reference to FIGS. 8 to 10.

The person in charge of installation performs the installation work (74) using an installation screen displayed on the image forming apparatus or the device management system. The installation work (74) may be performed before the usage information registration (73). That is, the order in which the installation work (74) and the usage information registration (73) are performed is not particularly limited. Even when the usage information registration (73) is not performed, the second application can be used by the installation work (74) until the term of validity indicated by the installation license expires.

When the usage information registration (73) is performed, the license management server performs preparation of an update license (76). In the update license, the serial number of the image forming apparatus which is an object of the update license and the term of validity of the second application based on the update license are set as illustrated in FIG. 6C. In this embodiment, a contract start date and a contract end date of the second application are set as the term of validity of the second application.

In the image forming apparatus in which the second application is installed, inquiry of an update license (77) is automatically performed at the time of restarting, at a specific time, or the like. The license management server performs the usage information registration (73) when the inquiry of an update license is received, and performs transmission of an update license (78) when the update license is prepared.

The image forming apparatus having received the update license performs installation of an update license (79). Accordingly, the image forming apparatus can use the second application in a period from the contract start date to the contract end date. Thereafter, with update of the usage information registration, the processes from preparation of an update license (76) to installation of an update license (79) are performed to extend the term of validity.

That is, the license management server issues an update license in which the term of validity of the second application changes whenever usage information is registered (updated). The image forming apparatus enables the second application using the new update license acquired from the license management server and continues to use the second application. When the term of validity of the installation license has expired or the contract end date of the update license has elapsed without performing the usage information registration (73), the application is automatically stopped by the application managing unit 43 and thus cannot be used.

FIGS. 8 to 10 are flowcharts illustrating process routines of preparing (registering) a task (an installation task) for allowing the management server 1000 to install a second application in an image forming apparatus.

The process routines illustrated in FIGS. 8 to 10 are embodied by causing the CPU 10 to load and execute device management software in the RAM 12.

The management server 1000 prepares an installation task and requests the image forming apparatus to install the second application. Before an installation task is prepared, a user registers a second application and a license for the second application in the management server 1000.

Specifically, the user registers an application on a screen which is displayed by the UI control unit 310 under the control of the application managing unit 35 of the management server 1000. The user registers a license use for the installation on a screen which is displayed by the UI control unit 310 under the control of the license managing unit 37 of the management server 1000. The registered second application and the registered license are stored in the application data storage unit 38 and the license data storage unit 39, respectively.

In this embodiment, an installation license is used as a license which is used to install the second application, but the invention is not limited thereto. As described above, the second application can also be installed using an update license. The management server 1000 can acquire (download) the applied installation license or the applied update license from the image forming apparatus by instructing the image forming apparatus to uninstall the second application.

In Step S801, the installation managing unit 36 receives selection of an application to be installed from a user via the UI control unit 310. Here, the selected application may be a first application or may be a second application. Here, a plurality of applications may be selected. For example, the user may select an application to be installed from a selection screen, which is not illustrated, displayed by the UI control unit 310.

In Step S802, the installation managing unit 36 receives selection of an image forming apparatus as an installation destination from a user via the UI control unit 310. The user selects an image forming apparatus as an installation destination from a selection screen, which is not illustrated, displayed by the UI control unit 310. The image forming apparatuses 2000 connected to the network 3000 are searched in advance by the device searching unit 32 and then the selectable image forming apparatuses are acquired from the results of searching stored in the device data storage unit 34. Here, a plurality of image forming apparatuses may be selected.

It is assumed that which of the applications selected in Step S801 should be installed in which of the image forming apparatuses selected can be designated in Step S802. The image forming apparatuses selected in Step S802 may include an image forming apparatus for which an application to be installed is not designated. That is, in an installation task, only a license selected in Step S803 which will be described later can be delivered to the image forming apparatus selected in Step S802.

In Step S803, the installation managing unit 36 receives selection of a license for an application to be installed from the user via the UI control unit 310. For example, the user may select a license for an application to be installed from a license selection screen, which is not illustrated, displayed by the UI control unit 310. An update license can be selected as the license for the second application in addition to the installation license.

In this embodiment, a case in which an installation license is selected as a license for installing the second application will be particularly described. It is assumed that which of an installation license and an update license to use as a license for an application to be installed can be designated for each image forming apparatus selected in Step S802.

In Step S804, the installation managing unit 36 receives setting of a task such as a schedule for executing an installation task from a user via the UI control unit 310. For example, regarding the setting of a task, the user may set a task execution time from an input screen, which is not illustrated, displayed by the UI control unit 310. The task managing unit 33 instructs the installation managing unit 36 to execute a task on the basis of the schedule set in the task. Accordingly, the installation managing unit 36 executes the installation task.

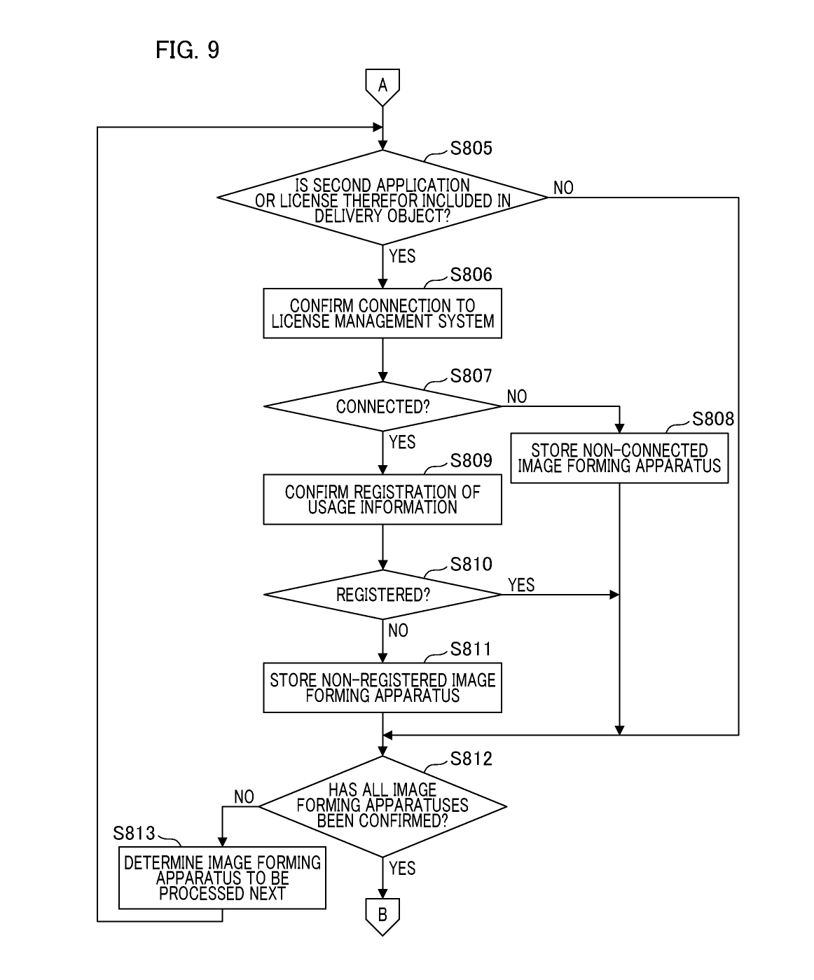

The processes of Steps S805 to S812 in FIG. 9 are repeatedly performed on all the image forming apparatuses selected in Step S802. First, in Step S805, the installation managing unit 36 determines whether a second application and an installation license are included regarding the application which is installed in an image forming apparatus to be processed and a license for the application. That is, in Steps S801 and S803, the installation managing unit 36 determines whether a second application and an installation license are selected as an application which is installed in an image forming apparatus to be processed.

As the installation task, an installation task for delivering only a license can also be prepared instead of delivering an application and a license for the application. In this case, in Step S805, it is determined whether an installation license is included as a license which is installed in the image forming apparatus to be processed.

In the subsequent processes for the installation task for delivering only a license, a part described as “a second application license and an installation license for the second application” has only to be changed to “an installation license for a second application.”

When there are a second application and an installation license for the second application, the process routine transitions to Step S806. When there are not a second application and an installation license for the second application, the process routine transitions to Step S812. In Step S806, the installation managing unit 36 instructs an image forming apparatus to be processed to confirm whether the image forming apparatus is connected to the license management system 4000.

This is because the image forming apparatus 2000 may not be able to communicate with the license management system 4000 due to a problem in settings associated with a network environment, a problem on a software management system side, or the like. When the instruction for confirmation is received, the application managing unit 43 of the image forming apparatus confirms connection to the license management system 4000, that is, communicates with the license management system 4000, and notifies (returns) the result of confirmation to the management server.

In Step S807, the installation managing unit 36 receives the result of confirmation from the image forming apparatus and determines whether the image forming apparatus is connected to the license management system 4000. The process routine transitions to Step S809 when the image forming apparatus is connected to (has succeeded in communicating with) the license management system 4000, and the process routine transitions to Step S808 when the image forming apparatus is not connected (has failed to communicate). In step S808, the installation managing unit 36 stores information of the image forming apparatus not connected to the license management system 4000 in the RAM 12. The stored information is used to display a warning in a subsequent step.

In Step S809, the installation managing unit 36 instructs the image forming apparatus to be processed to confirm whether the usage information thereof has been registered (where there is registration information) in the license management system 4000. The management server 1000 may inquire of the license management system 4000 about whether the usage information has been registered. When the instruction for confirmation is received, the application managing unit 43 of the image forming apparatus inquires of the license management system 4000 about whether the usage information has been registered, and notifies the management server of the confirmation result.

In Step S810, the installation managing unit 36 receives the result of confirmation from the image forming apparatus and determines whether the usage information of the image forming apparatus has been registered in the license management system 4000. The process routine transitions to Step S812 when the usage information has been registered, and the process routine transitions to Step S811 when the usage information has not been registered.

In Step S811, the installation managing unit 36 stores information of the image forming apparatus of which usage information has not been registered in the RAM 12. The stored information is used to display a warning in a subsequent step. In Step S812, the installation managing unit 36 determines whether the processes of Steps S805 to S811 have been performed on all the image forming apparatuses selected as an installation destination in Step S802. In other words, it is determined whether confirmation of connection to the license management system 4000 and registration confirmation of usage information have been performed on all the image forming apparatuses.

When confirmation of connection to the license management system 4000 and registration confirmation of usage information have been performed on all the image forming apparatuses, the process routine transitions to Step S814. When confirmation of connection to the license management system 4000 and registration confirmation of usage information have not been performed on all the image forming apparatuses, the process routine transitions to Step S813.

In Step S813, the installation managing unit 36 determines a next image forming apparatus to be processed, that is, to be subjected to confirmation of connection to the license management system 4000 and registration confirmation of usage information, in Steps S805 to S810. Then, the process routine returns to Step S805. Thereafter, the processes of Steps S805 to S813 are repeatedly performed until confirmation of connection to the license management system 4000 and registration confirmation of usage information have been performed on all the image forming apparatuses selected as an installation destination in Step S802.

In Step S814, the installation managing unit 36 determines whether there is information of the image forming apparatus stored in Step S808 or S811. That is, the installation managing unit 36 determines whether there is an image forming apparatus for which a warning is displayed. The process routine transitions to Step S815 when there is an image forming apparatus for which a warning is displayed, an installation task is prepared when there is no image forming apparatus for which a warning is displayed, and then the process routines illustrated in FIGS. 8 to 10 end.

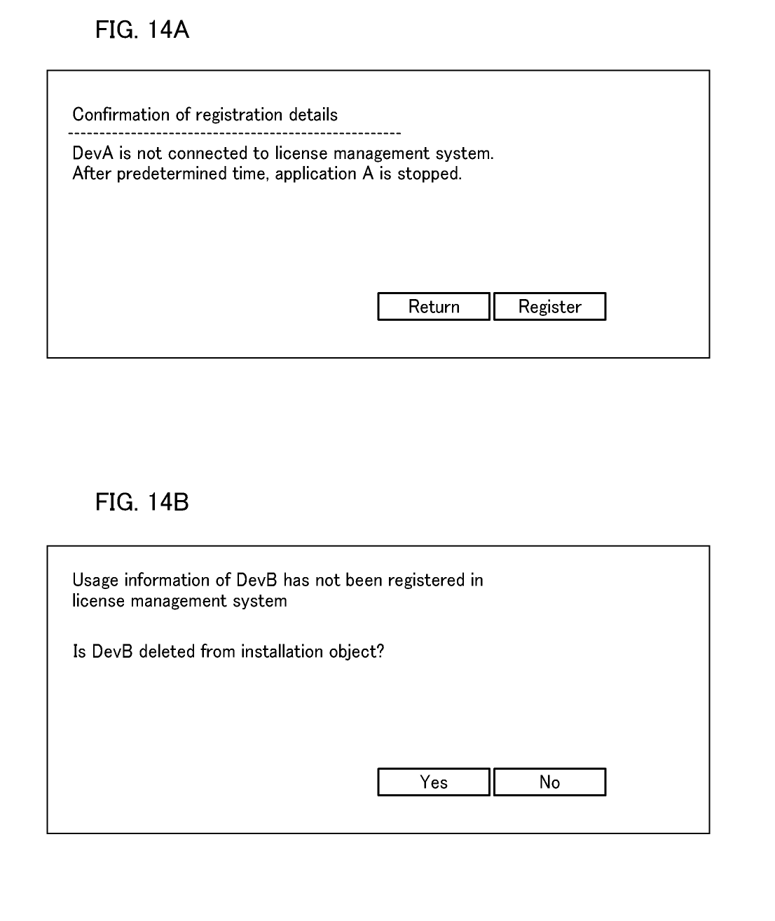

In Step S815, the installation managing unit 36 controls the UI control unit 310 such that a warning is displayed. Examples of the warning include a warning indicating that the image forming apparatus is not connected to the license management system 4000 and a warning indicating that the usage information of the image forming apparatus has not been registered and ascertaining whether the image forming apparatus is an installation target of the application. In any warning, the user is notified that the license to be delivered will not be updated. An example of the warning displayed in Step S815 will be described later with reference to FIGS. 14A and 14B.

In Step S816, the installation managing unit 36 determines whether there is an image forming apparatus of which usage information has not been registered in the license management system 4000. That is, it is determined whether there is an image forming apparatus of which information is stored in Step S811. When there is an image forming apparatus of which usage information has not been registered, the process routine transitions to Step S817. On the other hand, when there is no image forming apparatus of which usage information has not been registered, an installation task for an image forming apparatus other than the image forming apparatus for which a warning has been displayed is prepared, and the process routines illustrated in FIGS. 8 to 10 end.

In Step S817, the installation managing unit 36 determines whether an image forming apparatus of which usage information has not been registered in the license management system 4000 is an installation target. This determination is performed on the basis of an instruction from the user in response to a warning indicating that the usage information of the image forming apparatus has not been registered and ascertaining whether the image forming apparatus is an installation target of the application among the warnings displayed in Step S815.

For example, a confirmation screen illustrated in FIG. 14B which will be described later is displayed, a user is caused to select whether an image forming apparatus of which usage information has not been registered is an installation target of the application, and the determination of Step S817 is performed on the basis of the selection. That is, it is arbitrary whether the second application and the installation license for the second application should be delivered to an image forming apparatus of which usage information has not been registered, and the user can select whether to deliver the second application and the installation license.

When it is determined in Step S817 that an image forming apparatus of which usage information has not been registered in the license management system 4000 is not an installation target, the process routine transitions to Step S818. On the other hand, when an image forming apparatus of which usage information has not been registered in the license management system 4000 is an installation target, installation tasks for all the image forming apparatuses selected as an installation destination in Step S802 are prepared. Then, the process routine illustrated in FIGS. 8 to 10 end. All the image forming apparatuses selected as an installation destination in Step S802 include an image forming apparatus of which usage information has not been registered.

In Step S818, the installation managing unit 36 deletes the image forming apparatus determined not to be an installation target in Step S817 from the image forming apparatuses selected as an installation destination in Step S802. Then, installation tasks for the image forming apparatuses other than the image forming apparatus determined not to be an installation target among the image forming apparatuses selected as an installation destination in Step S802 are prepared, and the process routines illustrated in FIGS. 8 to 10 end.

In this embodiment, when an image forming apparatus in which the second application should be installed is not connected to the license management system 4000, a warning indicating that the license to be delivered will not be updated is displayed. When usage information of an image forming apparatus in which the second application should be installed has not been registered in the license management system 4000, a warning indicating that the license to be delivered will not be updated is displayed. In addition to display of a warning, it can be selected whether the corresponding image forming apparatus should be excluded from installation targets.

Even when the above-mentioned warnings are displayed, the second application can be enabled (usage thereof can be started) using the installation license. As described above, when a remaining term of validity in which the application can be enabled and which is described in the installation license expires, the application cannot be used. In this embodiment, even when a warning is displayed, the second application is installed, but the invention is not limited thereto. For example, an image forming apparatus for which a warning is displayed may be automatically excluded from installation objects.

<Sequence of Preparing Installation Task of Second Application>

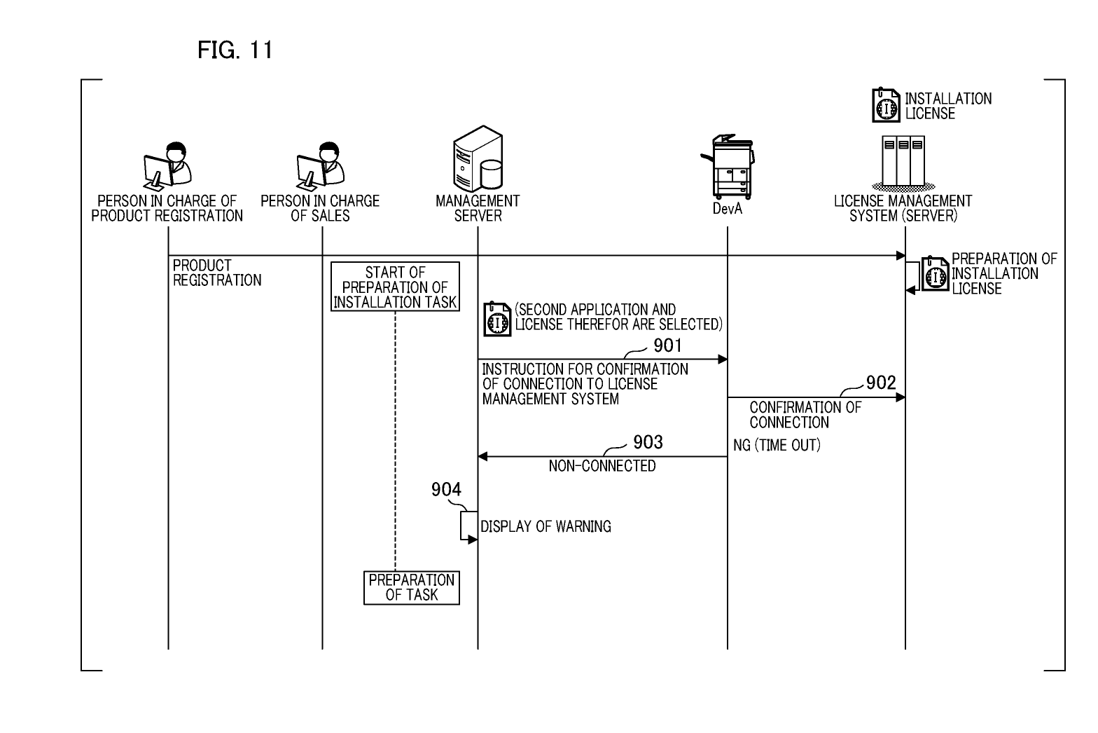

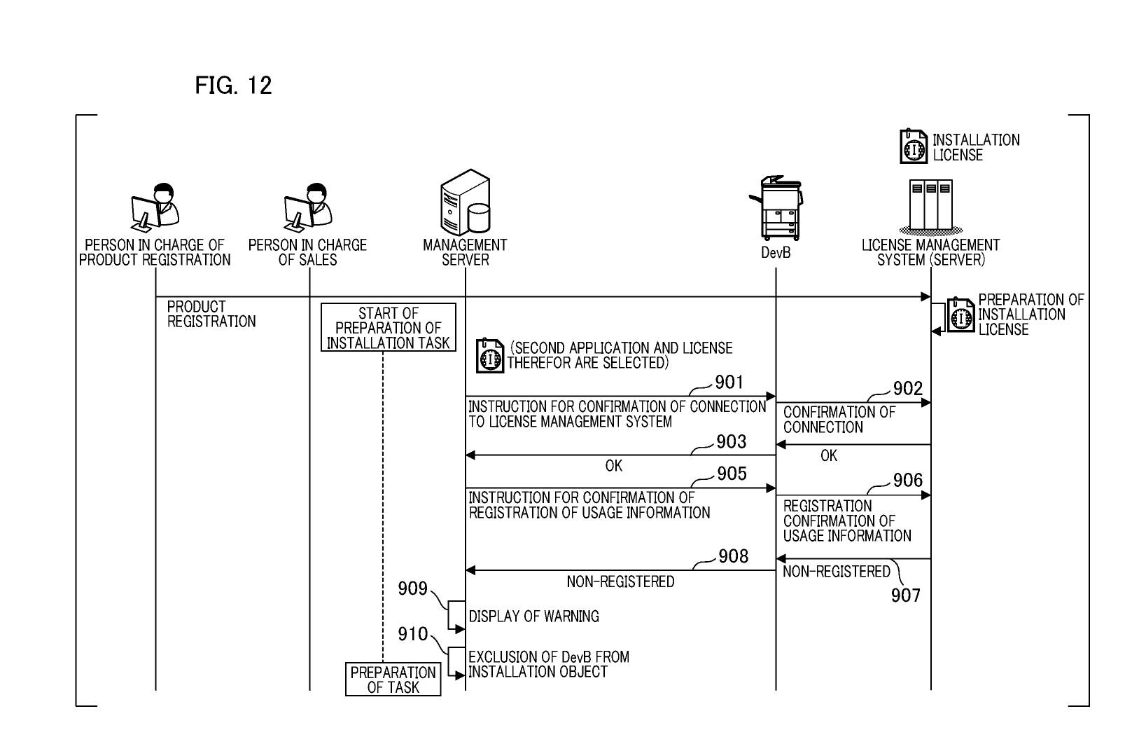

FIGS. 11 and 12 are diagrams illustrating an example of an operating sequence before an installation task of a second application is prepared.

In FIGS. 11 and 12, the processes corresponding to FIGS. 8 to 10 will be referred by the same step numbers in the following description.

FIG. 11 is a diagram illustrating an example in which the management server 1000 prepares a task for installing a second application A in an image forming apparatus DevA. As illustrated in FIG. 7, it is assumed that a person in charge of product registration registers the application A in the license management server of the license management system 4000 before an installation task is prepared. Accordingly, an installation license for the application is issued.

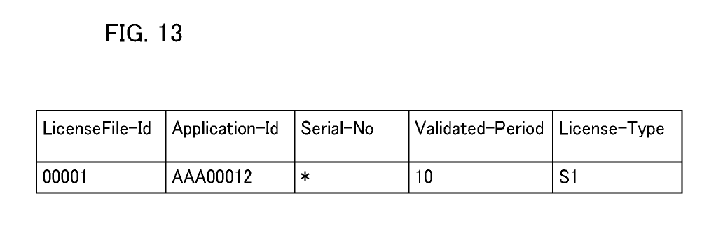

As described above with reference to FIG. 8, a second application and the installation license for the second application are registered in the management server 1000 before the installation task is prepared. Here, it is assumed that the image forming apparatus DevA is not connected to the license management system 4000. An application ID (Application-ID) of the application A is assumed to be AAA00012. Details of a license selected in the prepared installation task (S803) are illustrated in FIG. 13.

The license illustrated in FIG. 13 is a license for enabling the application with an application ID (Application-ID) of AAA00012. The type of the license (License-Type) illustrated in FIG. 13 is S1. When it is mentioned that the type of a license is “S1,” this means that it is a license for a second application. When it is mentioned that the type of a license is “N1,” this means that it is a license for a first application.

Validated-Period is set as a term of validity, and details thereof are set to 10, that is, a remaining term of validity after the application has been installed is 10 days.

Referring back to FIG. 11, when the installation task is prepared, a second application is selected (S801), and an installation license for the second application is selected as a license which is used for installation (S803). At this time, it is determined that there are the second application and the installation license for the second application (S805), and instruction for confirmation of connection (901) to the license management system 4000 is performed on the image forming apparatus DevA (S806).

As described above, when an installation task for the image forming apparatus DevA is prepared, the second application may not be selected and only the installation license for the second application may be selected.

When the instruction for confirmation of connection is received, the image forming apparatus DevA performs connection confirmation (902) to the license management system 4000. Since the image forming apparatus DevA is not connected to the license management system 4000, the image forming apparatus DevA times out and performs notification (903) indicating that the image forming apparatus DevA is not connected (non-connection) to the management server 1000. The management server 1000 performs display of a warning (904) in response to the notification (S815).

FIG. 14A illustrates an example of a warning which is displayed when an image forming apparatus as an installation destination is not connected to the license management system 4000.

The warning describes which image forming apparatus is not connected to the license management system and that the application is disabled after a predetermined time passes when the application is installed in the image forming apparatus as it were.

Accordingly, the user can recognize that there is an image forming apparatus which is not connected to the license management system 4000 and can additionally select whether to prepare a task for installing the application in the image forming apparatus.

FIG. 12 is a diagram illustrating an example in which the management server 1000 prepares a task for installing a second application A in an image forming apparatus DevB. Similarly to FIG. 11, it is assumed that a person in charge of product registration registers the application A in the license management server of the license management system 4000 before an installation task is prepared. Accordingly, an installation license for the application is issued. As described above with reference to FIG. 8, a second application and an installation license for the second application are registered in the management server 1000 before the installation task is prepared.

Here, it is assumed that the image forming apparatus DevB is connected to the license management system 4000 and usage information thereof has been registered. An application ID (Application-ID) of the application A is assumed to be AAA00012 similarly to FIG. 11.

Details of the license selected in the prepared installation task (S803) are the same as details illustrated in FIG. 13 similarly to FIG. 11. That is, the application A is a second application, and Validated-Period is set to 10 as a term of validity.

In FIG. 12, when the installation task is prepared, it is assumed that a second application is selected (S801) and an installation license for the second application is selected as a license which is used for installation (S803). At this time, it is determined that there are the second application and the installation license for the second application (S805), and instruction for confirmation of connection (901) to the license management system 4000 is performed on the image forming apparatus DevB (S806).

As described above, when an installation task for the image forming apparatus DevA is prepared, the second application may not be selected and only the installation license for the second application may be selected.

When the instruction for confirmation of connection is received, the image forming apparatus DevB performs connection confirmation (902) to the license management system 4000. Since the image forming apparatus DevB is connected to the license management system 4000, the image forming apparatus DevB performs notification (903) indicating that the image forming apparatus DevB is connected to the management server 1000. Then, the management server 1000 performs instruction for confirmation (905) of whether usage information of the image forming apparatus DevB has been registered in the license management system 4000 (S809).

When the instruction for confirmation of registration of usage information is received, the image forming apparatus DevB performs registration confirmation (906) of usage information in the license management system 4000. Since the usage information of the image forming apparatus DevB has not been registered in the license management system 4000, the image forming apparatus DevB receives notification (907) indicating that fact from the license management system 4000. When notification indicating that it is not connected is received from the license management system 4000, the image forming apparatus DevB transmits notification indicating that it is not connected (908) to the management server 1000.

The management server 1000 performs display of a warning (909) in response to the notification (S815). When an instruction to exclude the image forming apparatus DevB from installation objects is received from the user, the management server 1000 excludes the image forming apparatus DevB from the installation destination which is set in the installation task (910).

FIG. 14B illustrates an example of a warning which is displayed when usage information of an image forming apparatus as an installation destination has not been registered in the license management system 4000.

The warning describes which image forming apparatus has been subjected to registration of usage information in the license management system and whether the image forming apparatus should be excluded from the installation object.

Similarly to FIG. 14A, the warning may indicate that the application is disabled after a predetermined period passes when the application is installed in the image forming apparatus as it were. Accordingly, the user can recognize that there is an image forming apparatus of which usage information has not been registered in the license management system and can additionally select whether to prepare a task for installing the application in the image forming apparatus.

### Second Embodiment

In a second embodiment, an example in which a second application is reinstalled in an image forming apparatus when the second application is installed in the image forming apparatus will be described below. When the second application is reinstalled after it has been uninstalled, the second application can be installed using an installation license for the second application which has been once used.

The installation license for the second application which has been once used can be used to install the second application in the same image forming apparatus, but cannot enable (start) the application.

The configuration of the device management system according to this embodiment and the hardware and software configurations of the devices are the same as those in the device management system according to the first embodiment. Therefore, the same elements as in the first embodiment will be referred to by the same reference signs and description thereof will be omitted.

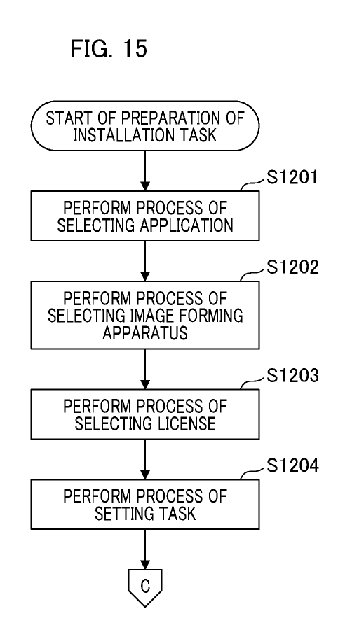

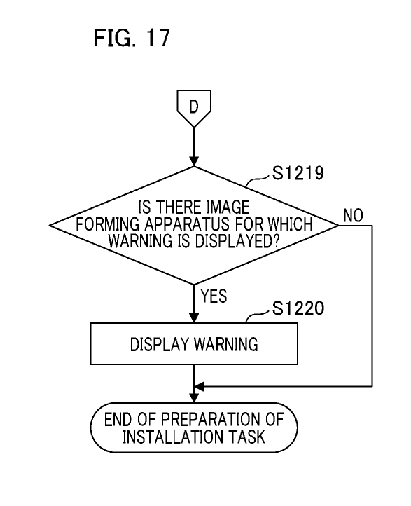

FIGS. 15 to 17 are flowcharts illustrating process routines of causing the management server 1000 to prepare a task (an installation task) for installing a second application in an image forming apparatus according to this embodiment.

The process routines illustrated in FIGS. 15 to 17 are realized by causing the CPU 10 to load and execute device management software in the RAM 12.

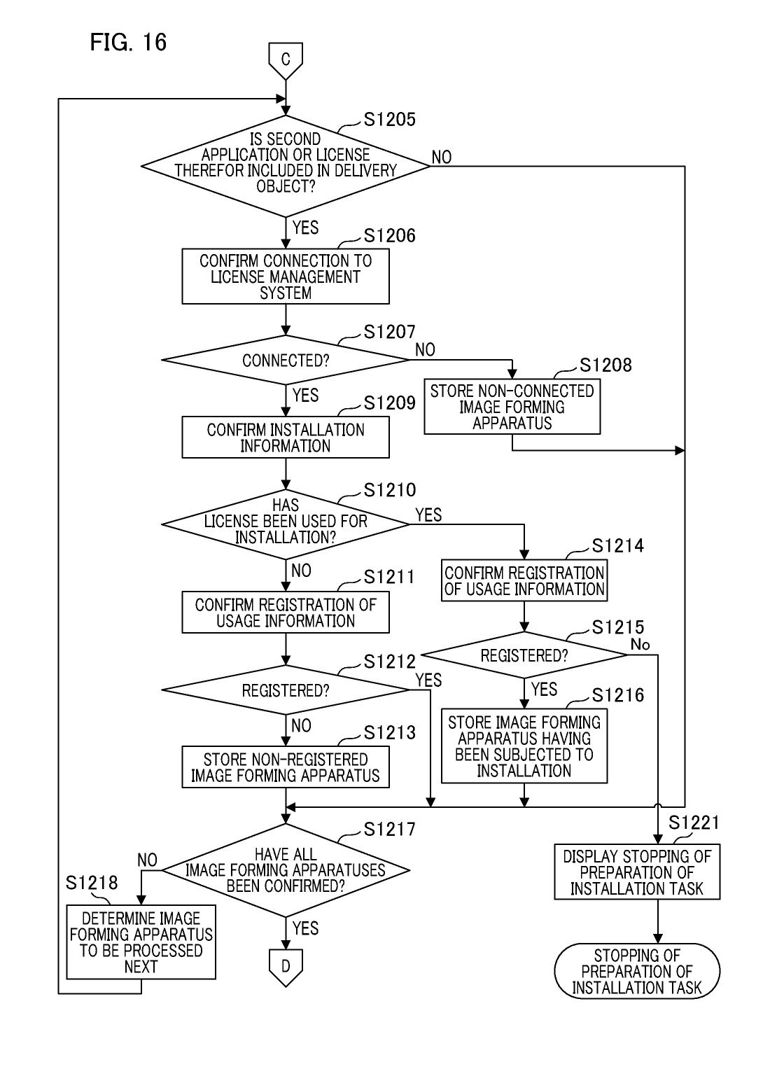

The processes of Steps S1201 to S1204 are the same as the processes of Steps S801 to S804 and detailed description thereof will not be repeated. Through the processes of Steps S1201 to S1204, the installation managing unit 36 receives selection of an application to be installed, an image forming apparatus as an installation destination, and a license for the application and setting of an execution date of the installation task. Then, the processes of Steps S1205 to S1217 in FIG. 16 are repeatedly performed on all the image forming apparatuses selected in Step S1202.

The processes of Steps S1205 to S1208 are the same as the processes of Steps S805 to S808 and detailed description thereof will not be repeated. Through the processes of Steps S1205 to S1208, the installation managing unit 36 instructs an image forming apparatus to be processed to perform the followings when a second application and an installation license are included as an application which is installed in the image forming apparatus. The installation managing unit 36 performs connection confirmation of the image forming apparatus to the license management system 4000, that is, causes the image forming apparatus to communicate with the license management system 4000 and instructs to ascertain whether the communication is possible.

In the installation task, an installation task of delivering only the license instead of delivering the license for the application along with the application can also be prepared. In this case, in Step S805, it is determined whether an installation license is included as a license which is installed in an image forming apparatus to be processed.

In the following processes, regarding an installation task of delivering only a license, a part described as “a second application and a license for the second application” has only to be replaced with “a license for the second application.”

Then, information of the image forming apparatus which is not connected is stored in the RAM 12. On the other hand, when an installation license is included as a license which is installed in an image forming apparatus to be processed and the image forming apparatus is connected to the license management system 4000, the process routine transitions to Step S1209.

In Step S1209, the installation managing unit 36 instructs the image forming apparatus to be processed to confirm whether the license selected in Step S1203 has been used for installation. When the instruction for confirmation is received, the application managing unit 43 of the image forming apparatus confirms installation information including an installation history of the apparatus or the like and notifies the management server of the result of confirmation.

The image forming apparatus stores information of LicenseFile-Id described in the license file used for installation in the apparatus as installation information. The application managing unit 43 confirms whether the stored information includes LicenseFile-Id of the license file of which confirmation has been instructed.

In Step S1210, the installation managing unit 36 receives the result of confirmation from the image forming apparatus and determines whether the image forming apparatus has used the license selected in Step S1203 for installation. The process routine transitions to Step S1214 when the license selected in Step S1203 has been used for installation in the image forming apparatus as an installation destination, and the process routine transitions to Step S1211 when the license has not been used for installation.

The processes of Steps S1211 to S1213 are the same as the processes of Steps S809 to S811 and detailed description thereof will be omitted. Through the processes of Steps S1211 to S1213, the installation managing unit 36 instructs the image forming apparatus as an installation destination to confirm whether usage information thereof has been registered in the license management system 4000. Then, the installation managing unit 36 stores information of the image forming apparatus of which usage information has not been registered in the RAM 12.

On the other hand, when usage information of the image forming apparatus as an installation destination has been registered in the license management system 4000, the process routine transitions to Step S1217. The processes of Steps S1214 and 1215 are the same as the processes of Steps S1211 and S1212 and detailed description thereof will be omitted. The installation managing unit 36 instructs the image forming apparatus as an installation destination to confirm whether usage information thereof has been registered in the license management system 4000, and the process routine transitions to Step S1216 when usage information thereof has been registered.

Then, in Step S1216, the installation managing unit 36 stores information of the image forming apparatus of which usage information has been registered in the RAM 12. The stored information is used for displaying a warning in a subsequent step. That is, it is warned that an image forming apparatus which has used the license selected in Step S1203 for installation and of which usage information has been registered in the license management system 4000 cannot start usage of the application with the same installation license.

On the other hand, when it is determined in Step S1215 that usage information of the image forming apparatus as an installation destination has not been registered in the license management system 4000, the process routine transitions to Step S1221. This is a case in which the image forming apparatus as an installation destination has already used the license selected in Step S1203 for installation and usage information of the image forming apparatus has not been registered in the license management system 4000.

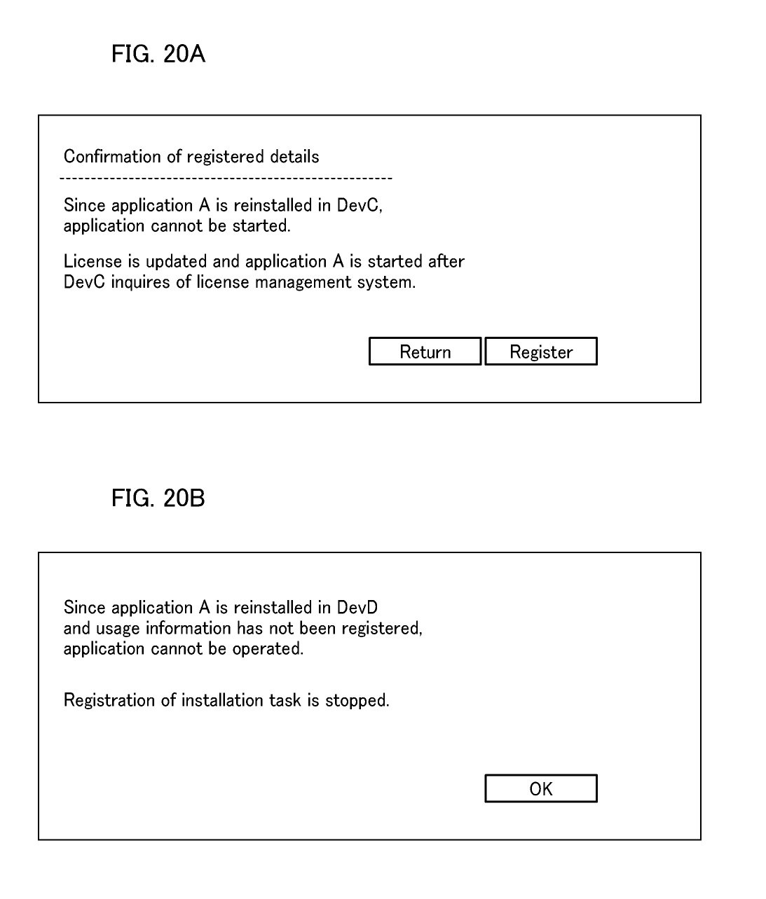

In this case, in Step S1221, the installation managing unit 36 stops preparing of the installation task. The installation managing unit 36 displays that preparing of the installation task is stopped via the UI control unit 310. An example of the display will be described later with reference to FIGS. 20A and 20B.

The processes of Steps S1217 to S1220 are the same as the processes of Steps S812 to S815 and detailed description thereof will be omitted. Through the processes of Steps S1217 to S1220, the installation managing unit 36 controls the UI control unit 310 such that a warning is displayed and then prepares the installation task when there is an image forming apparatus for which a warning is displayed.

Similarly to the first embodiment, examples of the displayed warning include a warning indicating that an image forming apparatus is not connected to the license management system 4000 and a warning indicating that usage information of an image forming apparatus has not been registered. With any warning, the user is notified that the license to be delivered will not be updated.

In this embodiment, a warning indicating reinstallation using an installation license already used for an image forming apparatus is used. This warning may include a message indicating that the application cannot be enabled reusing the installation license and thus the application cannot be immediately started, that is, usage of the application cannot be immediately started. An example of this warning will be described later with reference to FIGS. 20A and 20B.

Similarly to the first embodiment, Steps S816 to S818 are performed after the process of Steps S1220 has been performed, and a user may be caused to confirm whether the image forming apparatus as a warning target is an installation destination.

In this way, in this embodiment, when an image forming apparatus in which a second application is reinstalled is included in the image forming apparatuses in which the second application should be installed, a warning indicating that fact or the like is displayed. When usage information of an image forming apparatus which is subjected to reinstallation using the installation license has not been registered in the license management system, the installation itself is not performed and a message indicating that fact is displayed instead of displaying a warning. Since the application cannot operate even when the application is installed in the image forming apparatus, preparing of the installation task for the image forming apparatus can be stopped in advance.

<Sequence of Preparing Installation Task of Second Application>

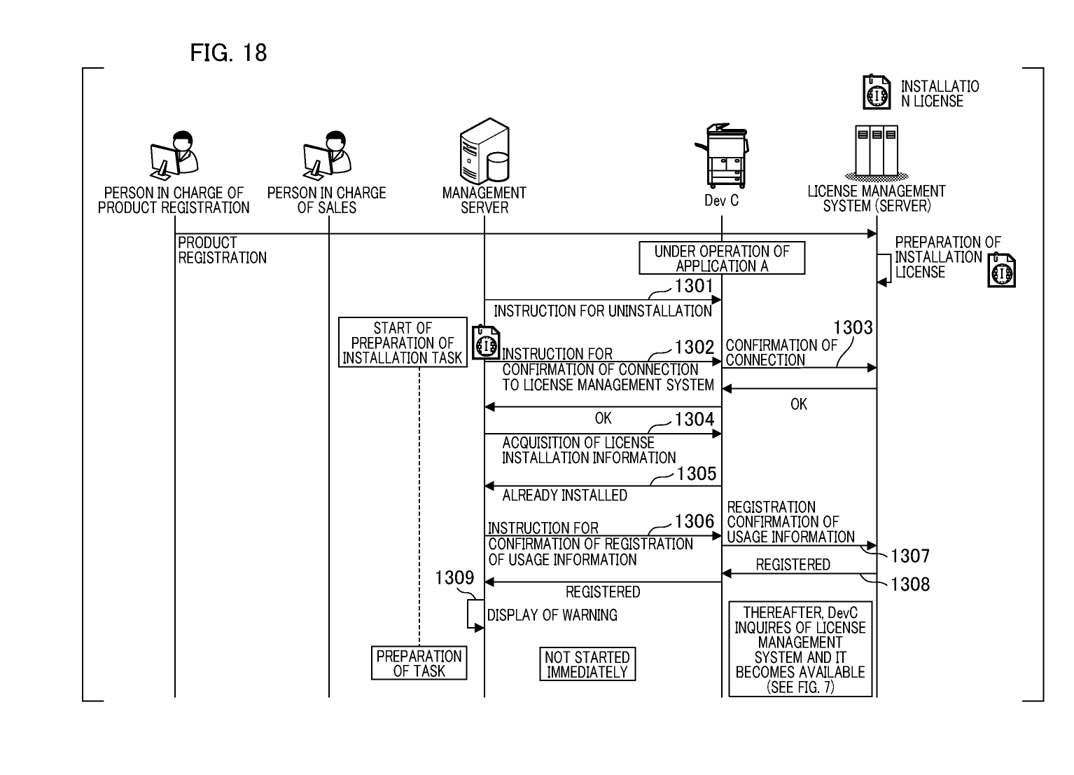

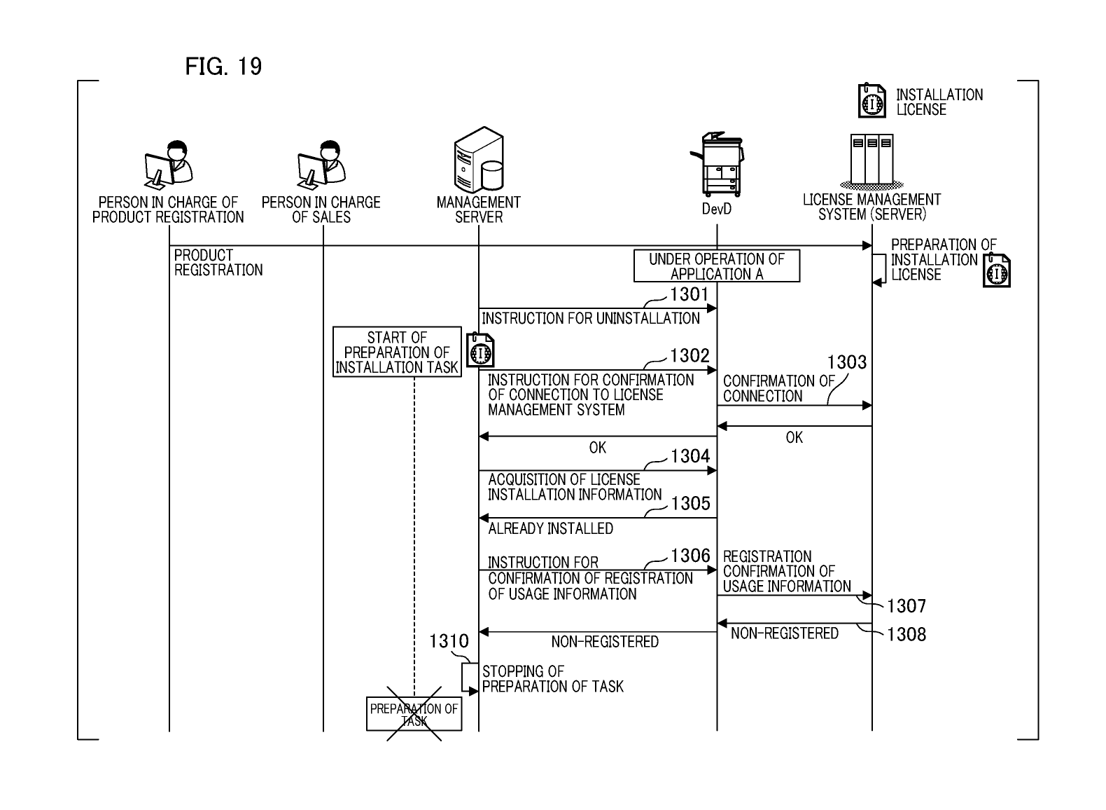

FIGS. 18 and 19 are diagrams illustrating an example of an operating sequence before an installation task of a second application is prepared.

In FIGS. 18 and 19, the processes corresponding to FIGS. 15 to 17 will be referred by the same step numbers in the following description. The processes common to FIGS. 11 and 12 will not be described.

FIG. 18 is a diagram illustrating an example in which the management server 1000 prepares a task for reinstalling the second application A in an image forming apparatus DevC having already used the second application A and having uninstalled the second application A. Here, it is assumed that the image forming apparatus DevC is connected to the license management system 4000 and usage information thereof has been registered.

An application ID (Application-ID) of the application A is assumed to be AAA00012 and details of a license selected in the prepared installation task (S1203) are set to the same as illustrated in FIG. 13. That is, the license illustrated in FIG. 13 is a license for enabling an application with an application ID (Application-ID) of AAA00012.

The type of the license (License-Type) is S1. Validated-Period is set as a term of validity, and details thereof are set to 10, that is, a remaining term of validity after the application has been installed is set to 10 days.

In FIG. 18, it is assumed that the application A is operating in the image forming apparatus DevC and the management server 1000 has instructed the image forming apparatus DevC to uninstall the application A (1301). The image forming apparatus DevC deletes the application A when the instruction for uninstallation is received.

The management server 1000 can extract (download) the applied installation license or the applied update license from the image forming apparatus DevC by instructing the image forming apparatus DevC to uninstall the application. Hereinafter, a case in which the management server 1000 prepares a task for reinstalling the second application A in the image forming apparatus DevC in this state will be described.

When the installation task is prepared, it is assumed that a second application is selected (S1201) and an installation license for the second application is selected as a license which is used for installation (S1203). At this time, it is determined that there are the second application and the installation license for the second application (S1205), and instruction for confirmation of connection (1302) to the license management system 4000 is performed on the image forming apparatus DevC (S1206).

As described above, when an installation task for the image forming apparatus DevC is prepared, the second application may not be selected and only the installation license for the second application may be selected.

When the instruction for confirmation of connection is received, the image forming apparatus DevC performs connection confirmation (1303) to the license management system 4000 similarly to the first embodiment. Since the image forming apparatus DevC is connected to the license management system 4000, the image forming apparatus DevC performs notification indicating that the image forming apparatus DevC is connected to the management server 1000.

The management server 1000 confirms (1304) whether the application A has been installed in the image forming apparatus DevC (S1209). Since the operating application A has been uninstalled in the image forming apparatus DevC, the image forming apparatus DevC notifies the management server 1000 (1305) that the application A has been installed in the image forming apparatus DevC.

The management server 1000 instructs (1306) the image forming apparatus DevC to confirm whether usage information thereof has been registered in the license management system 4000 (S1214). When the instruction for confirmation of registration of usage information is received, the image forming apparatus DevC inquires (1307) of the license management system 4000 about registration of usage information.

Since usage information thereof has been registered in the license management system 4000, the image forming apparatus DevC is notified (1308) that fact by the license management system 4000. When notification indicating that it has been registered is received from the license management system 4000, the image forming apparatus DevC notifies the management server 1000 that it has been registered. The management server 1000 displays a warning (1309) in response to the notification (S1216 and S1220).

FIG. 20A illustrates an example of a warning which is displayed when a second application is reinstalled in an image forming apparatus as an installation destination and usage information of the image forming apparatus has been registered in the license management system 4000.

The warning describes in which image forming apparatus an application is installed using the same installation license and that the image forming apparatus cannot immediately start of usage of the application A when the application has been installed.

In order for the image forming apparatus DevC to start usage of the application A, it is necessary to inquire of the license management system from DevC and to acquire an update license of the application A. A user can recognize this information and then can prepare an installation task for reinstallation in the image forming apparatus.

FIG. 19 is a diagram illustrating an example in which the management server 1000 prepares a task for reinstalling the second application A in an image forming apparatus DevD having already used the second application A and having uninstalled the second application A similarly to FIG. 18. Here, it is assumed that the image forming apparatus DevD is connected to the license management system 4000 and usage information thereof has not been registered.

Similarly to FIG. 18, an application ID (Application-ID) of the application A is assumed to be AAA00012 and details of a license selected in the prepared installation task (S1203) are set to the same as illustrated in FIG. 13.

In FIG. 19, similarly to FIG. 18, it is assumed that the application A is operating in the image forming apparatus DevD and the management server 1000 has instructed the image forming apparatus DevD to uninstall the application A (1301). The image forming apparatus DevD deletes the application A when the instruction for uninstallation is received.

The management server 1000 can extract (download) the applied installation license or the applied update license from the image forming apparatus DevD by instructing the image forming apparatus DevD to uninstall the application. Hereinafter, a case in which the management server 1000 prepares a task for reinstalling the second application A in the image forming apparatus DevD in this state will be described.

When the installation task is prepared, it is assumed that installation of a second application is selected and an installation license for the second application is selected as a license which is used for installation (S1203). At this time, it is determined that there are the second application and the installation license for the second application (S1205), and instruction for confirmation of connection (1302) to the license management system 4000 is performed on the image forming apparatus DevD (S1206).

As described above, when an installation task for the image forming apparatus DevD is prepared, the second application may not be selected and only the installation license for the second application may be selected.

In FIG. 19, the processes from the instruction for confirmation of connection (1302) to the registration confirmation of usage information (1307) are the same as illustrated in FIG. 18 and thus description thereof will be omitted. Since usage information thereof has been registered in the license management system 4000, the image forming apparatus DevD is notified (1308) that fact by the license management system 4000. When notification indicating that it has not been registered is received from the license management system 4000, the image forming apparatus DevD notifies the management server 1000 that it has not been registered. The management server displays a warning indicating that preparing of the installation task is stopped and stops preparing of the installation task (1310) in response to the notification.

FIG. 20B is an example in which a message indicating that preparing of an installation task is stopped.

In the display illustrated in FIG. 20B, a message indicating in which image forming apparatus an application has been already installed using the installation license and that usage information thereof has not been registered in the license management system and thus an installation task for the image forming apparatus is not prepared.

The invention may be applied to a system including a plurality of devices (for example, a host computer, an interface device, a reader, and a printer) or may be applied to a system (for example, a copier or a facsimile) including a single device.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-164715, filed Aug. 29, 2017, which is hereby incorporated by reference wherein in its entirety.

What is claimed is:

1. A management apparatus comprising:
a memory storing instructions; and
a processor executing the instructions causing the management apparatus to:
transmit an instruction causing an image forming apparatus to communicate with a license management system to the image forming apparatus when setting of delivery of an application and an installation license for the application or the installation license to the image forming apparatus is performed;
display a warning indicating that a license to be delivered to the image forming apparatus will not be updated when the license management system does not manage registration information of the image forming apparatus or the image forming apparatus has failed to communicate with the license management system in accordance with the instruction; and
deliver the application and the installation license or the installation license on the basis of the setting of delivery when the license management system manages the registration information of the image forming apparatus and the image forming apparatus has succeeded in communicating with the license management system in accordance with the instruction.

2. The management apparatus according to claim 1, wherein a remaining period in which the application is enabled is set in the installation license.

3. The management apparatus according to claim 1,
wherein the image forming apparatus in which the application has been installed using the installation license requests the license management system for an update license for the application to continuously use the application.

4. The management apparatus according to claim 1, wherein control is performed so that the setting of delivery is not performed if it is determined that the installation license has been reused in the image forming apparatus with reference to an installation history of licenses in the image forming apparatus when the setting of delivery for the image forming apparatus is performed and the license management system does not manage the registration information of the image forming apparatus.

5. The management apparatus according to claim 1, wherein, in the displaying, a warning indicating that the application is not able to be immediately started in the image forming apparatus is displayed if it is determined that the installation license has been reused in the image forming apparatus with reference to an installation history of licenses in the image forming apparatus when the setting of delivery for the image forming apparatus is performed and the license management system manages the registration information of the image forming apparatus.

6. The management apparatus according to claim 5, wherein the instructions further cause the management apparatus to acquire the installation license for the application from the image forming apparatus when the application is uninstalled from the image forming apparatus.

7. The management apparatus according to claim 1, wherein, in the displaying, selection of whether or not the setting of delivery is to be performed to the image forming apparatus is received when the license management system does not manage the registration information of the image forming apparatus.

8. A method for controlling a management apparatus, the method comprising:
transmitting an instruction causing an image forming apparatus to communicate with a license management system to the image forming apparatus when setting of delivery of an application and an installation license for the application or the installation license to the image forming apparatus is performed;
displaying a warning indicating that a license to be delivered to the image forming apparatus will not be updated when the license management system does not manage registration information of the image forming apparatus or the image forming apparatus has failed to communicate with the license management system in accordance with the instruction; and
delivering the application and the installation license or the installation license on the basis of the setting of delivery when the license management system manages the registration information of the image forming apparatus and the image forming apparatus has succeeded in communicating with the license management system in accordance with the instruction.

9. A non-transitory storage medium on which is stored a computer program for making a computer execute:
transmitting an instruction causing an image forming apparatus to communicate with a license management system to the image forming apparatus when setting of delivery of an application and an installation license for the application or the installation license to the image forming apparatus is performed;
displaying a warning indicating that a license to be delivered to the image forming apparatus will not be updated when the license management system does not manage registration information of the image forming apparatus or the image forming apparatus has failed to communicate with the license management system in accordance with the instruction; and
delivering the application and the installation license or the installation license on the basis of the setting of delivery when the license management system manages the registration information of the image forming apparatus and the image forming apparatus has succeeded in communicating with the license management system in accordance with the instruction.
